(19) United States
(12) Patent Application Publication
(10) Pub. No.: US 2018/0208380 A1
(43) Pub. Date: Jul. 26, 2018

(54) Linerless Adhesive Carry Handle, Roll of Linerless Adhesive Carry Handles, and Method of Manufacture Thereof

(71) Applicant: Dykam Ein Harod (Meuhad) Agricultural Cooperative Association Ltd., Kibbutz Ein Harod Meuhad (IL)

(72) Inventors: Iftach Amami, Kibbutz Ein Harod Meuhad (IL); Yoav Brand, Kibbutz Ein Harod Meuhad (IL)

(73) Assignee: Dykam Ein Harod (Meuhad) Agricultural Cooperative Association Ltd., Kibbutz Ein Harod Meuhad (IL)

(21) Appl. No.: 15/879,896

(22) Filed: Jan. 25, 2018

Related U.S. Application Data
(60) Provisional application No. 62/450,624, filed on Jan. 26, 2017.

(51) Int. Cl. B65D 75/56; B25G 3/34; B25G 1/10; B31D 1/06

(52) U.S. Cl. CPC B65D 75/56; B31D 1/065; B25G 1/10; B25G 3/34

(57) ABSTRACT

A linerless adhesive carry handle. The carry handle can include a single layer of substrate material having a substantially elongated shape, two separate adhesive areas disposed at opposite ends of the substrate material, on the bottom surface thereof, a central non-adhesive area disposed on the bottom surface of the substrate between the two separate adhesive areas, and a release coating disposed on the top surface of the substrate, wherein the carry handle does not include a second layer of material covering the adhesive.

### CROSS-REFERENCE TO RELATED APPLICATIONS

This application claims priority to U.S. Provisional Patent Application No. 62/450,624, filed on Jan. 26, 2017 and entitled “Linerless Adhesive Article and Method of Manufacture Thereof,” the contents of which are hereby incorporated in their entirety by reference.

### BACKGROUND

Bulky items such as cardboard boxes, packs of multiple water bottles, large packs of paper towels, and the like are typically difficult to carry for the consumer due to their large size, unwieldy shape, and, frequently, heavy weight. To aid in carrying such objects, carry handles may be attached to the object. Typically, such carry handles are formed from a rectangular strip of substrate material, the bottom surface of which is fully coated with a pressure-sensitive adhesive. A release liner can then be coupled to the adhesive. On the ends of the carry handle, the release liner is peeled away and discarded to expose the adhesive, while in the central portion of the handle, the liner remains attached as an adhesive cancellation layer, i.e., to cover the adhesive so as to prevent it from contacting the user's hands or other surfaces. Such carry handles are typically provided in sheets. Yet other variations of carry handles are provided in stacks. Such carry handles include an adhesive cancellation section, while the ends of one carry handle are adhered to the top surface of the ends of another carry handle, and so forth, forming a stack of carry handles.

Such designs for carry handles present several disadvantages. The release layer of the handle creates waste both during manufacture and at the point of use. Having a peel-and-discard release liner is wasteful and can create litter at the point of use. Even in cases without a release liner for the ends of the handle, the liner is still used as adhesive cancellation for the central portion, requiring additional material for manufacture of the handle, and increasing the cost and complexity of manufacture. Furthermore, as indicia may be printed on the adhesive cancellation liner, in such situations the material for the substrate must be transparent so that the indicia can be seen through it, limiting choice of materials for both the user and manufacturer. Yet further disadvantages of such designs include the difficulty of handling and transporting both sheets of carry handles and stacks of carry handles. Sheets of carry handles take up a large relative amount of area and are unwieldy to handle. Stacks of carry handles have loose central portions, which lend to instability in storing such stacks vertically for bulk transport, and which can allow the handles to be damaged easily.

An adhesive carry handle that reduces waste, decreases cost and difficulty of manufacturing, and lends itself to easy handling and safe, reliable bulk storage and transport is therefore desired.

### SUMMARY

According to one exemplary embodiment, a linerless adhesive carry handle is disclosed. The carry handle can include a single layer of substrate material having a substantially elongated shape, two separate adhesive areas disposed at opposite ends of the substrate material, on the bottom surface thereof, a central non-adhesive area disposed on the bottom surface of the substrate between the two separate adhesive areas, and a release coating disposed on the top surface of the substrate, wherein the carry handle does not include a second layer of material covering the adhesive.

According to another exemplary embodiment, a roll of linerless adhesive carry handles is disclosed. The roll can include a continuous strip of linerless adhesive carry handles arranged in end-to-end relation, each carry handle being separated from an adjacent carry handle by a line of weakness. The continuous strip can be arranged in a spiral configuration, with the adhesive areas being adhered to the top surface of the next-inner layer of the spiral, without any second material that is not the substrate being adhered to the adhesive areas or disposed between the layers of the spiral.

According to another exemplary embodiment, a method of manufacturing a roll of adhesive carry handles is disclosed. The method can include providing a roll of substrate material, increasing the surface tension of the material by a corona treater, printing indicia on the top surface of the substrate material, applying a release coating to the top surface of the substrate material, inverting the substrate material, providing transverse lines of weakness in the substrate material at desired intervals, each pair of lines of weakness defining the length of a carry handle therebetween, intermittently applying adhesive to the bottom surface of the substrate material such that each carry handle includes two separate adhesive areas at the opposite ends of the carry handle, providing longitudinal cuts in the substrate material, each pair of longitudinal cuts defining the width of a carry handle therebetween, thereby creating a plurality of continuous strips of carry handles, rewinding the continuous strips of carry handles in a spiral configuration, such that the adhesive areas are adhered to the top surface of the next-inner layer of the spiral, and such that no second material that is not the substrate is adhered to the adhesive areas or disposed between the layers of the spiral.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a top view of an exemplary embodiment of a linerless adhesive carry handle.

FIG. 2 is a bottom view of an exemplary embodiment of a linerless adhesive carry handle.

FIG. 3 is a side view of an exemplary embodiment of a linerless adhesive carry handle.

FIG. 4 is a top view of an exemplary continuous strip of linerless adhesive carry handles.

FIG. 5 is a bottom view of an exemplary continuous strip of linerless adhesive carry handles.

FIG. 6 shows an exemplary roll of linerless adhesive carry handles.

FIG. 7 is a bottom view of another exemplary embodiment of a linerless adhesive carry handle.

FIG. 8 is a bottom view of another exemplary embodiment of a continuous strip of linerless adhesive carry handles.

FIG. 9 shows an exemplary roll of another exemplary embodiment of linerless adhesive carry handles.

FIG. 10 is a bottom view of another exemplary embodiment of a linerless adhesive carry handle.

FIG. 11 shows an exemplary method for manufacturing continuous strips of linerless adhesive carry handles.

FIG. 12 shows an exemplary apparatus for manufacturing continuous strips of linerless adhesive carry handles.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

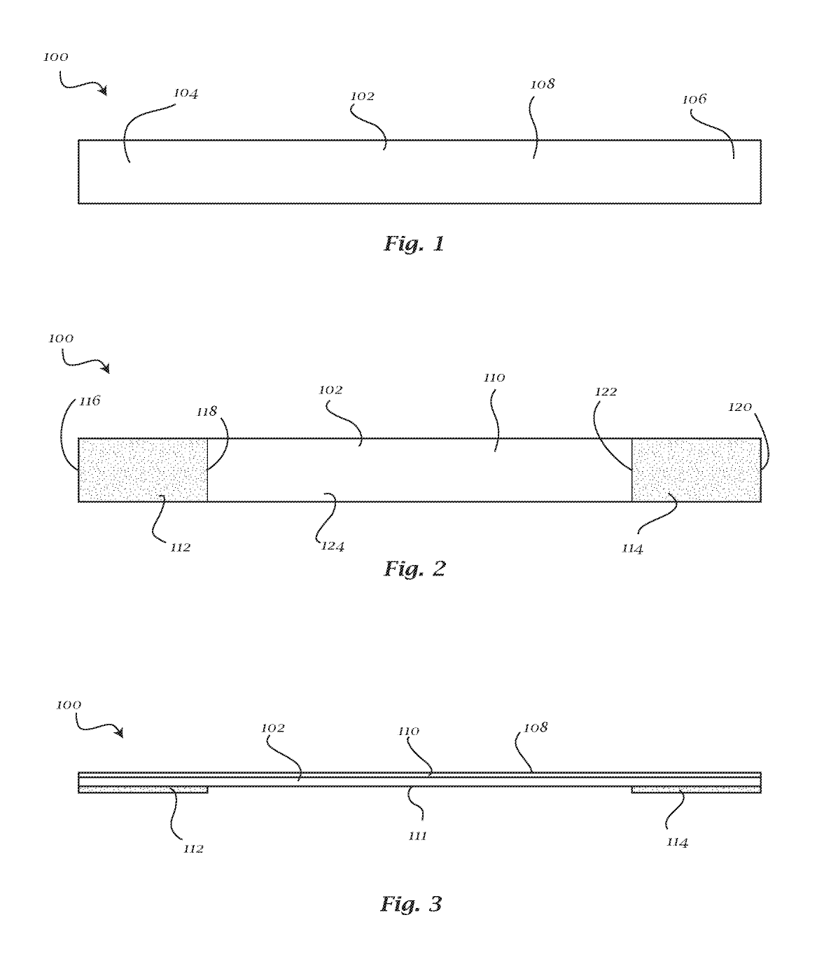

According to at least one exemplary embodiment, and as shown in FIGS. 1-3, a linerless adhesive carry handle 100 is disclosed. The linerless adhesive carry handle 100 can include a generally elongated body 102, a first end 104, and a second end 106. Body 102 may be formed from any desired substrate material that enables carry handle 100 to function as described herein. The substrate material may be, for example, a single-layer, non-laminated material having a uniform thickness. Exemplary substrate materials may include, but are not limited to, polypropylene (PP), polyethylene terephthalate (PET), polyvinyl chloride (PVC), direct thermal paper, calcium carbonate and high-density polyethylene-based paper (“Stone Paper”), or any other substrate material that enables handle 100 to function as described herein. Polypropylene substrates may also include monoaxially oriented PP (MOPP) film and biaxially oriented PP film (BOPP). In some embodiments, the tensile strength of the substrate material may be similar to or greater than half of the weight of the object to be carried. In some exemplary embodiments, the top surface 108 of body 102 may include printed indicia thereon, such as text, images, logos, machine-readable codes, and the like. In some embodiments, indicia may also be imparted to body 102 by thermal printing processes, subsequent to the manufacturing process. A release coating 110 may be disposed over top surface 108, and may be coextensive with body 102. The release coating may have a release force under 2N/25 mm, or preferably, under 0.75N/25 mm.

The bottom surface 110 of body 102 may include a first adhesive area 112 disposed at first end 104, and a second adhesive area 114 disposed at second end 106. The first adhesive area 112 may extend from a first edge 116 of body 102 to a first boundary line 118 spaced inwardly on body 102 from first edge 116. Similarly, the second adhesive area 114 may extend from a second edge 120 of body 102 to a second boundary line 122 spaced inwardly on body 102 from second edge 120. A non-adhesive area 124 may be disposed between boundary lines 118, 122. As the adhesive is applied in two separate areas to bottom surface 110, rather than to the entire area of bottom surface 110, a separate application of an adhesive cancellation layer to create the non-adhesive area is not necessary. Consequently, the material used for the substrate may be non-transparent, as the necessity to view the indicia printed on the adhesive cancellation layer is obviated. The adhesive used for adhesive areas 112, 114, may be a pressure-sensitive adhesive and may be, but is not limited to, a hot-melt adhesive or UV-curable hot-melt adhesive, as desired. The adhesive peel force may be over 4N/25 mm at 180°.

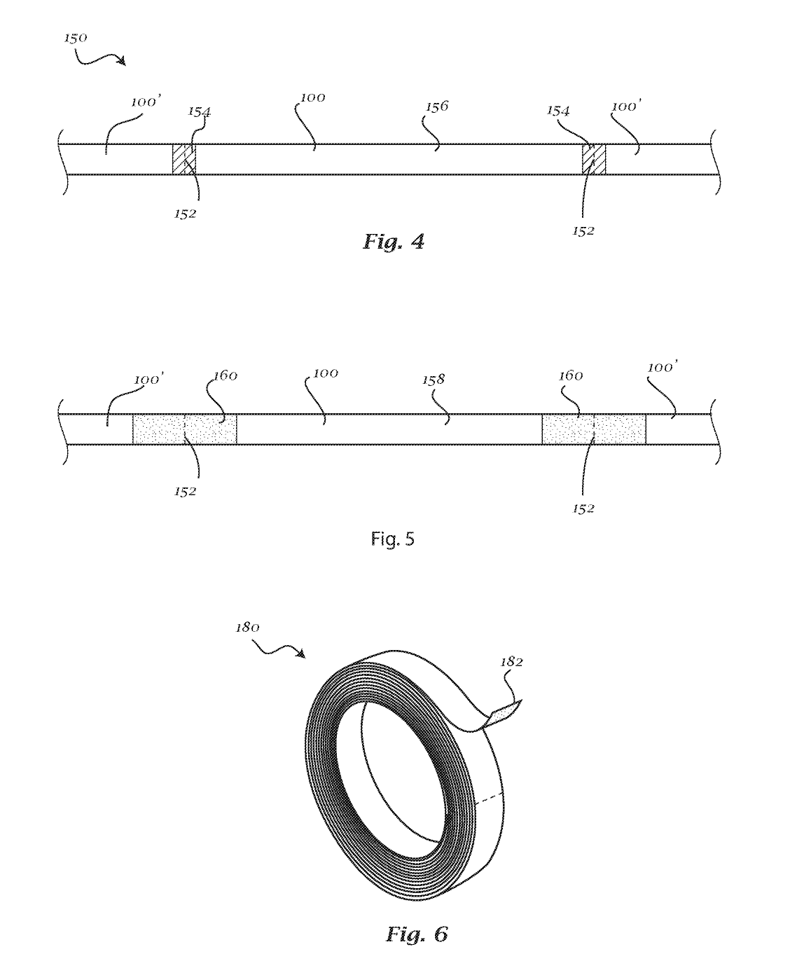

FIGS. 4-5 show a continuous strip 150 of detachably connected linerless adhesive carry handles 100, in which a first end 104 of a carry handle 100 is connected to a second end 106 of an adjacent carry handle 100′. The detachable connection can be provided by a line of weakness 152, for example a perforated line, formed through the width and thickness of strip 150 at desired intervals. To facilitate positioning of the lines of weakness 152, cue marks 154 may be imprinted at desired intervals on the top or bottom surfaces of strip 150 during manufacturing, as discussed further below. The intervals between each pair of cue marks 154, and consequently between each pair of lines of weakness 152, may be uniform or variable, as desired. Similarly, on the bottom surface 158 of strip 150, adhesive areas 160 may be applied proximate lines of weakness 152, such that each adhesive area 160 is approximately bisected by each line of weakness 152. The continuous strip 150, therefore, can include a plurality of carry handles 100 having uniform-length or non-uniform length, as desired. The breaking force of the lines of weakness may be greater than the release force of the adhesive from the release layer.

The continuous strip 150 of carry handles 100 may be provided as a roll 180. The roll 180 may be used on its own or in conjunction with a dispenser, so as to facilitate the ease of holding the roll and dispensing handles therefrom. The roll 180 is formed from a continuous spiral of the strip 150 that is wound around a central core 182 and extends outward therefrom. The adhesive areas 160 disposed on the bottom surface 158 of strip 150 can adhere to the top surface 156 of the portion of strip 150 that forms the next inner layer of the continuous spiral. Because of such adhesion between the spiral layers, the roll 180 can be maintained in a tightly wound configuration, and, consequently, the likelihood of the roll becoming unwound due to handling or transport is eliminated. Likewise, the likelihood of the roll becoming deformed into a conical shape by way of pressure on the longitudinal edges of the strip is also eliminated. However, due to the presence of release coating 110 on the top surface 156 of strip 150, the outermost layer of roll 180 may be easily detached from the next-inner layer of the roll, by peeling off the terminal edge 182 of the continuous strip and pulling the terminal edge away from the roll. The strength of the adhesive relative to the release value of the release coating may be selected as desired so as to enable roll 180 to be unwound as described herein.

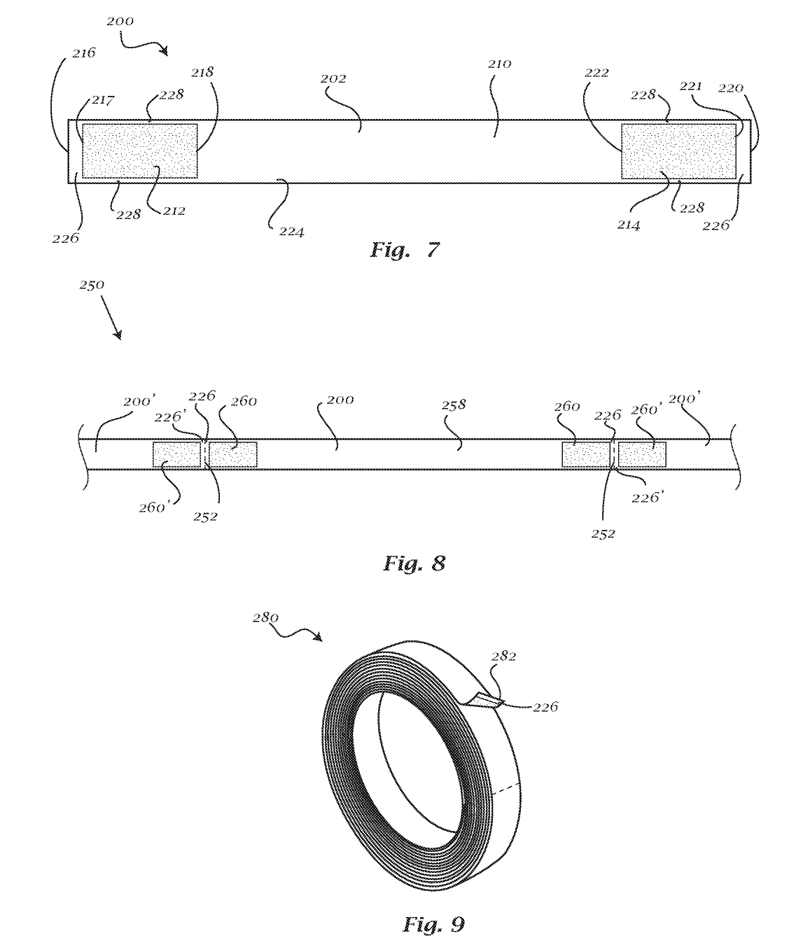

Another exemplary embodiment of the linerless adhesive carry handle, continuous strip of carry handles, and roll is shown in FIGS. 7-9 and denoted by reference numerals 200, 250, and 280, respectively, with similar features being denoted by similar reference numerals, but with a hundreds digit of 2. Carry handle 200, strip 250, and roll 280 have a substantially similar structure and configuration to carry handle 100, strip 150, and roll 180, respectively, except as described below.

The bottom surface 210 of carry handle 200 may include a first adhesive area 212 disposed at first end 204, and a second adhesive area 214 disposed at second end 206. The first adhesive area 112 may extend from a first boundary line 217 spaced inwardly from first edge 216 to a second boundary line 218 spaced inwardly on body 202 from first boundary line 217. Similarly, the second adhesive area 214 may extend from a third boundary line 221 spaced inwardly from second edge 220 to a fourth boundary line 222 spaced inwardly on body 202 from third boundary line 221. A non-adhesive area 224 may be disposed between boundary lines 218, 222. The spacing of adhesive areas 212, 214 inwardly from edges 216, 220, respectively, can provide non-adhesive tabs 226, which can allow for easier peeling off of an edge of carry handle 200 from the roll of carry handles 280. In some exemplary embodiments, the longitudinal edges of adhesive areas 212, 214 may also be spaced apart from the longitudinal edges of body 202, thereby providing non-adhesive areas 228 at the longitudinal edges. Non-adhesive areas 228 can reduce the likelihood of adhesive bleeding past the longitudinal edges, thereby allowing for smooth cutting of the bracelets during production and preventing undesired adhesion at the edges during handling.

As shown in FIG. 8, during manufacture of the continuous strip of adhesive carry handles 250, two adhesive areas 260 are applied per carry handle 200, proximate the ends thereof. The adhesive areas 260 are applied with a gap between them and the lines of weakness 252, thereby creating the tabs 226. The line of weakness 252 may approximately bisect the non-adhesive area between an adhesive area 260 and an adhesive area 260′ of an adjacent adhesive carry handle 200′. When disposed in a roll 280, the non-adhesive tab 226 facilitates the peeling off the terminal edge 282 of the continuous strip, prior to pulling the edge away from the roll, as shown in FIG. 9.

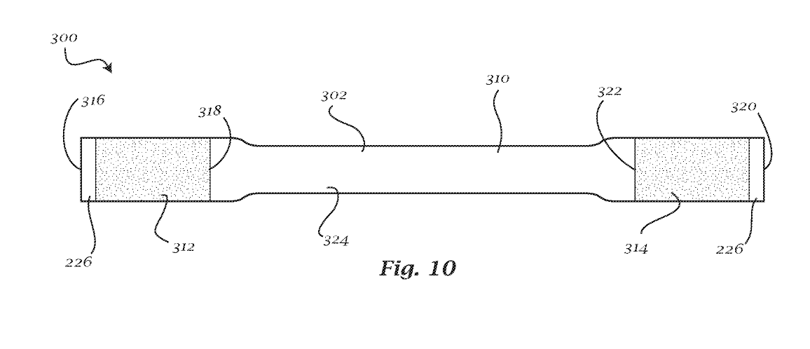

Another exemplary embodiment of the linerless adhesive carry handle is shown in FIG. 10 and denoted by reference numeral 300, with similar features being denoted by similar reference numerals, but with a hundreds digit of 3. Carry handle 300 has a substantially similar structure and configuration to carry handles 100 and 200, except as described below. Carry handle 300 may have a non-uniform width. For example, for a portion of the length between the adhesive areas 312, 318, handle 300 may have a width that is narrower than the width of the adhesive areas. This can facilitate ease of handling by the user by providing a narrower non-adhesive handle portion to grip, or can allow for larger adhesive areas for use with heavier objects. Carry handle 300 may be provided in a continuous strip of handles as well as in a roll, substantially as described above.

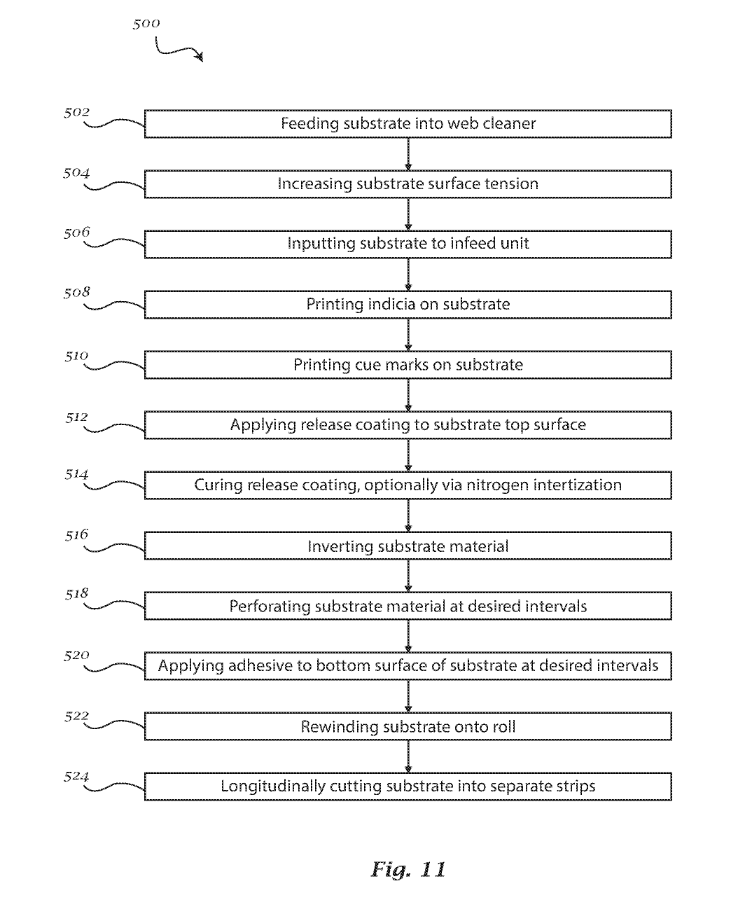

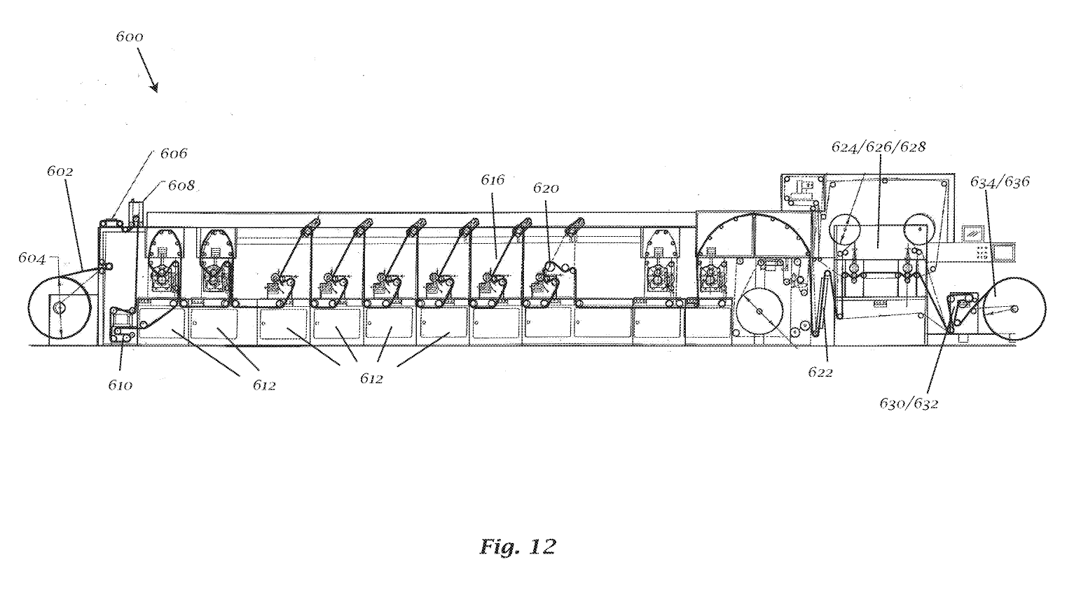

FIG. 11 shows an exemplary process 500, and FIG. 12 shows an exemplary apparatus 600 for manufacturing an exemplary embodiment of a continuous strip of carry handles and a roll of said strip. The manufacturing process 500 can be a one-pass process from raw material to final product. The substrate raw material 602 may be provided on a large spool or roll 604. At step 502, the substrate material may be fed into a web cleaner 606 so as to remove any dust or other residue from the substrate material. Subsequently, at step 504, the surface tension of the substrate material is increased by corona treater 608, so as to facilitate the adhesion of any printing inks, release coatings, and adhesives to the substrate material. The raw material may then be passed, at step 506, to infeed unit 610. Indicia may be printed on the top surface of substrate 602 at step 508, by one or more printing units 612. The printing units may be gravure printers, flexographic printers, or any other desired printing unit that enables carry handle 100 and process 500 to function as described herein.

Subsequently, at step 510, cue marks may be printed on the substrate material 602 in a cue mark printing unit 616, which may be similarly be any suitable type of printing unit. After printing of the cue mark, a release coating can be applied, at step 512, to the top surface of substrate material 602 by release application unit 620. In the event that an oxygen-sensitive polymer is utilized as the release coating material, the release application unit 620 may further perform nitrogen inertization during the curing of the release coating at step 514, thereby facilitating rapid curing of oxygen-sensitive coatings.

The release-coated substrate material may then pass over a turn bar 622, which, at step 516, inverts the substrate material such that the orientation of the top and bottom surfaces is reversed from the preceding steps. The inverted substrate material then passes to perforation unit 624. The perforation unit 624 includes a scanning unit 626 for recognizing the previously printed cue marks, and a die cutting unit 628, which, at step 518, imparts to the substrate material a perforated line of weakness that corresponds to each cue mark.

The inverted substrate then passes to adhesive application unit 630. The adhesive application unit 630 includes a scanning unit 632 for recognizing the cue marks. At step 520, areas of adhesive are intermittently applied by adhesive application unit 630 to the bottom surface of the substrate material at desired intervals, such that each area of adhesive is approximately bisected by a corresponding line of weakness in the substrate material. The longitudinal length of the adhesive areas, as well as the longitudinal placement of the line of weakness within the adhesive area may vary based on the lengths of the corresponding adhesive carry handles.

Subsequent to adhesive application, the printed, release-coated, adhesive-coated, and perforated substrate material substrate material is wound on roll 634, at step 522. At step 524, a cutting unit 636 longitudinally cuts the substrate material so as to separate the substrate material into a plurality of continuous strips 150. Transverse cuts are also performed by cutting unit 636 so as to separate the continuous strips from the wound roll, at desired intervals.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A linerless adhesive carry handle, comprising:
a single layer of substrate material having a substantially elongated shape;
two separate adhesive areas disposed at opposite ends of the substrate material, on the bottom surface thereof;
a central non-adhesive area disposed on the bottom surface of the substrate between the two separate adhesive areas; and
a release coating disposed on the top surface of the substrate;
wherein the carry handle does not include a second layer of material covering the adhesive.

2. The carry handle of claim 1, further comprising a non-adhesive tab disposed between an adhesive area and a proximate transverse edge of the carry handle.

3. The carry handle of claim 1, further comprising longitudinal non-adhesive areas disposed between an adhesive area and the longitudinal edges of the carry handle.

4. The carry handle of claim 1, wherein the width of at least a portion of the central non-adhesive area is different than the width of the adhesive areas.

5. The carry handle of claim 1, wherein the substrate material is a single-layer, non-laminated material having a uniform thickness.

6. The carry handle of claim 1, wherein the substrate material is non-transparent.

7. The carry handle of claim 1, wherein the peel force of the adhesive is over 4N/25 mm at 180°.

8. The carry handle of claim 1, wherein the release force of the release coating is under 2N/25 mm.

9. A roll of linerless adhesive carry handles, comprising:
a continuous strip of linerless adhesive carry handles arranged in end-to-end relation, each carry handle being separated from an adjacent carry handle by a line of weakness;
wherein each carry handle comprises a single layer of substrate material having a substantially elongated shape, two separate adhesive areas disposed at opposite ends of the substrate material on the bottom surface thereof, and a central non-adhesive area disposed on the bottom surface of the substrate between the two separate adhesive areas, and a release coating disposed on the top surface of the substrate;
wherein the continuous strip is arranged in a spiral configuration, with the adhesive areas being adhered to the top surface of the next-inner layer of the spiral; and
wherein no second material that is not the substrate is adhered to the adhesive areas or disposed between the layers of the spiral.

10. The roll of claim 9, further comprising a non-adhesive tab disposed between an adhesive area of each carry handle and the proximate line of weakness between the carry handle and an adjacent carry handle.

11. The roll of claim 9, further comprising longitudinal non-adhesive areas disposed between an adhesive area and the longitudinal edges of each carry handle.

12. The roll handle of claim 9, wherein the width of at least a portion of the central non-adhesive area of each carry handle is different than the width of the adhesive areas of the carry handle.

13. The roll of claim 9, wherein the substrate material is a single-layer, non-laminated material having a uniform thickness.

14. The roll of claim 9, wherein the substrate material is non-transparent.

15. The roll of claim 9, wherein the peel force of the adhesive is over 4N/25 mm at 180°.

16. The roll of claim 9, wherein the release force of the release coating is under 2N/25 mm.

17. A method of manufacturing a roll of adhesive carry handles, comprising:
providing a roll of substrate material;
increasing the surface tension of the material;
printing indicia on the top surface of the substrate material;
applying a release coating to the top surface of the substrate material;
inverting the substrate material;
providing transverse lines of weakness in the substrate material at desired intervals, each pair of lines of weakness defining the length of a carry handle therebetween;
intermittently applying adhesive to the bottom surface of the substrate material such that each carry handle includes two separate adhesive areas at the opposite ends of the carry handle;
providing longitudinal cuts in the substrate material, each pair of longitudinal cuts defining the width of a carry handle therebetween, thereby creating a plurality of continuous strips of carry handles;
rewinding the continuous strips of carry handles in a spiral configuration, such that the adhesive areas are adhered to the top surface of the next-inner layer of the spiral, wherein no second material that is not the substrate is adhered to the adhesive areas or disposed between the layers of the spiral.

18. The method of claim 17, further comprising curing the release coating by nitrogen inertization.

19. The method of claim 17, wherein the adhesive is applied such that a non-adhesive area is disposed between each adhesive area and a proximate line of weakness.

20. The method of claim 17, further comprising cutting the substrate material such that the width of at least a portion of a non-adhesive area disposed between two adhesive areas is different than the width of the adhesive areas.
